(19) United States
(12) Patent Application Publication
(10) Pub. No.: US 2005/0163978 A1
(43) Pub. Date: Jul. 28, 2005

(54) Article having a surface showing adhesive properties

(76) Inventors: Esben Strobech, Horsholm (DK); Frank Berg Rasmussen, Smorum (DK); Dorrit Diane Israelsson, Gentofte (DK)

Correspondence Address: JACOBSON HOLMAN, 400 SEVENTH STREET, N.W., WASHINGTON, DC, 20004, US

(21) Appl. No.: 10/769,982

(22) Filed: Feb. 3, 2004

(30) Foreign Application Priority Data
Jan. 27, 2004 (DK) PA 2004 00111

(51) Int. Cl. B32B 3/00

(52) U.S. Cl. 428/195.1

(57) ABSTRACT

It is an object of the invention to provide an adhesive element having an adhesive surface showing adhesive properties for adhering to a substrate wherein at least a part of the surface has been treated, resulting in alteration of the surface properties of the heat treated part of the surface. By heat treatment it is possible to provide an adhesive surface having parts showing different colour, water absorption properties, and/or adhesive properties.

### BACKGROUND OF THE INVENTION

1. Field of the Invention

The present invention relates to pressure sensitive adhesive compositions suitable for various medical applications and especially suitable for use for adhesion to the skin, in particular in the field of wound care or ostomy care. More specifically, this invention relates to adhesive compositions comprising a rubbery elastomeric base and optionally one or more water soluble or water swellable hydrocolloids dispersed therein, a method of grading the adhesive properties of an article having a surface showing adhesive properties the use of such adhesive compositions for the preparation of an article such as a continence care device, a wound dressing, breast prostheses or an adhesive wafer for an ostomy appliance, and to continence care devices, wound dressings, breast prostheses and ostomy appliances comprising such adhesive composition.

Pressure sensitive adhesives intended for medical use and in particular for adhesion to the skin of human beings must meet much more complex and varying conditions as compared to adhesives which are intended to be used on well-defined surfaces. This is to be ascribed inter alia to the variability of the surface structure and the surface film of the skin. The variation reflects inter alia age and races but also influence from the local climate is vital for the behaviour of the skin. Furthermore, there may be specific requirements to adhesives to be used for certain applications relating to use by human beings having diseases or handicaps. For instance, adhesives used for carrying ostomy bags or used for treatment of a skin ulcer will be affected not only by the normal variations and differences of the skin but also by the secretions from the stoma or from the wound. Thus, there is a need of an option of a local and individual grading of the adhesive properties of an adhesive to obtain a better and more reliable performance.

Various skin adhesive agents are used today for the above-mentioned purposes.

2. Description of the Related Art

It is known to provide adhesive surfaces with discrete areas comprising a further component. Thus, U.S. Pat. No. 4,711,781 to Nick et al. discloses a medicinal self-adhesive plaster which comprises a continuous adhesive coating on one surface of a carrier web, a plurality of non-permeable, separating film elements spaced from each other on the surface of the adhesive coating and a plurality of active ingredient elements containing a medication, each disposed on the surface of one of the separating film elements whereby the medicated active ingredient is isolated from the adhesive composition.

Furthermore, WO 99/38929 discloses an article having a surface showing adhesive properties and a cover layer for protecting the adhesive surface wherein a further component, located in indentations in the surface of the cover layer facing the adhesive surface without being in direct contact with the adhesive surface enables a grading of the adhesive properties of the article.

A very widespread embodiment of skin adhesive agents comprises a self-adhesive elastomeric matrix, in which water-absorbing, swelling particles, the so-called hydrocolloids, are dispersed.

It has been proposed to provide adhesive products having a surface showing adhesive properties and wherein parts of the surface show different properties by incorporating a second component as a part of the surface.

Thus, WO 89/05619 discloses an adhesive, flat skin barrier product comprising a plurality of alternating zones of material of at least two different types, in which at least one type of at least one type of zone consists of a skin-friendly self-adhesive material, the zones of material extending substantially in a parallel manner through the entire thickness of the product in a direction intersecting its flat surfaces.

Furthermore, WO 94/15562 discloses an adhesive, flat skin plate product for use as a semi-manufacture in the production of dressings, skin and wound care devices, fastening means for dressings, ostomy equipment, breast prostheses, wound drains and catheters for incontinence equipment, in particular for men, and for use in electrodes for application to the skin, the said skin plate product having an area being delimited by the periphery of the product, a first surface and a second surface being essentially parallel, and a thickness defined as the distance between the two surfaces measured in a direction being perpendicular to the surfaces, and the said skin plate product consisting of two or more essentially not mixed material units, at least two material units being of different material, of which at least one material unit is a skin friendly self-adhesive material, in which a first material unit extends throughout the area of the entire product, this material unit further constituting at least a portion of the first surface and the second surface respectively, and the additional material unit or units constituting the other portion of the first and the second surface, respectively, and extending at least somewhat into the thickness of the product in a direction which intersects the first or second surface of the product.

Preparation of such adhesive products having a surface showing adhesive properties and wherein parts of the surface show different properties by incorporating a second component as a part of the surface requires rather complicated and partly laborious production measures. Furthermore, the different components often have distinctly different rheological properties, which may cause both processing problems and mechanical stressing of the skin during use of the adhesive product.

It is an object of the present invention is to overcome the problems related to the complex demands related to effectively control the properties of a pressure sensitive adhesive by providing an adhesive element wherein the properties of the pressure sensitive adhesive are controlled without incorporating a second component in the adhesive element.

### SUMMARY OF THE INVENTION

It is an object of the invention to provide an adhesive element having an adhesive surface showing adhesive properties for adhering to a substrate wherein at least a part of the surface has been treated, resulting in alteration of the surface properties of the heat treated part of the surface. By the heat treatment it is possible to provide an adhesive surface having parts showing different colour, water absorption properties, and/or adhesive properties.

A first aspect of the present invention relates to an adhesive element comprising an adhesive layer, the adhesive layer comprising at least a first zone having a first surface associated with a first set of surface properties and at least one second zone having a second surface constituting at least a part of the adhesive surface of the adhesive element, the second surface being associated with a second set of surface properties differing from the first set of surface properties, wherein material as present in the second surface is obtainable by a heat treatment of material in the first surface, said material comprising a pressure sensitive adhesive composition.

A second aspect of the invention relates to a method of producing such an adhesive element.

### BRIEF DESCRIPTION OF THE DRAWINGS

The invention is disclosed more in detail with reference to the drawings in which

FIG. 1 shows a first embodiment of the adhesive element according to the invention, seen from the side intended for a skin surface.

FIG. 1b shows a section along the line A′-A′ of the adhesive element shown in FIG. 1.

FIG. 2 shows a second embodiment of the adhesive element according to the invention, seen from the side intended for a skin surface.

FIG. 2b shows a section along the line B′-B′ of the adhesive element shown in FIG. 2.

FIG. 3 shows a third embodiment of the adhesive element according to the invention, seen from the side intended for a skin surface.

FIG. 4 shows a forth embodiment of the adhesive element according to the invention, seen from the side intended for a skin surface.

### DETAILED DESCRIPTION OF THE PRESENT INVENTION

A first aspect of the present invention relates to an adhesive element comprising an adhesive layer, the adhesive layer comprising at least a first zone having a first surface associated with a first set of surface properties and at least one second zone having a second surface constituting at least a part of the adhesive surface of the adhesive element, the second surface being associated with a second set of surface properties differing from the first set of surface properties, wherein material as present in the second surface is obtainable by a heat treatment of material in the first surface, said material comprising a pressure sensitive adhesive composition.

The heat treatment may comprise the steps of:
providing an adhesive element comprising an adhesive layer,
selecting a heat source,
locating the adhesive layer and the heat source in a relationship enabling a heat treatment of the second surface of the adhesive layer, and
heat treating the second surface with the selected heat source for a sufficient time for obtaining the second set of properties.

An adhesive element according to the invention may thus be obtained by a heat treatment of at least a part of the surface of an adhesive layer, the heat treated material comprising at least a pressure sensitive adhesive composition. Th material of the first zone may thus not have been subjected to a heat treatment, whereas the material in the second zone has been subjected to a heat treatment, or even the material of the first zone may have been subjected to a heat treatment, whereas the material in the second zone has been subjected to a more intense heat treatment, such that material similar to the material of the second zone may be obtained by further heat treatment of the material in the first zone.

Material as present in the second surface may be obtained by a heat treatment of material in the first surface in the sense that the material of the second surface is chemically and structurally similar to material obtained by heat treatment of material in the first zone. Thus, no essential difference may be revealed by e.g. chemical analysis and inspection of the surface by means of electron microscopy.

The heat treatment may change the material chemically and structurally due to heat induced processes such as homogenisation or phase separation, changes in the length and/or conformation of polymer chains, surface roughening, foaming or loss of water. However, except for heat induced alterations by heat treatment, the material of the first zone and the second zone is the same.

Preferably the heat treatment should modify surface properties of the adhesive layer such as the temporal profile of water absorption into the adhesive layer, peel adhesion, tack, etc. The surface properties may be enhanced or reduced by the heat treatment.

The heat treatment may affect the material of the entire adhesive layer. Typically the modified material extends only to a depth constituting a minor part of the entire thickness of the adhesive layer. The modified material may e.g. extend to a depth of 1-100 μm, such as 50 μm.

The adhesive layer has an adhesive surface adapted to be exposed to the environment, e.g. to be connected to exterior objects such as skin. The adhesive surface may be topologically coherent or it may consist of a number of surface parts.

In the latter case, the first zone and the second zone may be present on the same surface part or on different surface parts of the adhesive layer. For some important applications the adhesive layer is topological coherent in the shape of a flat plate-like element.

The pressure sensitive adhesive composition comprises at least one adhesive component. The pressure sensitive adhesive composition may further comprise inclusions of non-adhesive components. The non-adhesive components are typically evenly distributed in a matrix constituted by the adhesive component, but may also be un-evenly distributed, such that the concentration of the non-adhesive component varies with depth in the adhesive layer i.e. varies as a function of the distance to the surface of the adhesive layer and/or the concentration of the non-adhesive component varies laterally i.e. varies as a function of position in a layer parallel to the surface of the adhesive layer. In one embodiment of the invention the pressure sensitive adhesive composition comprises a water-absorbing component, such as hydrocolloids. Pharmaceutically active agents is another example of non-adhesive components, which may for some applications be included in the pressure sensitive adhesive composition. The adhesive layer may comprise elements of more than one pressure sensitive adhesive composition and even elements of a non-adhesive composition. Different elements may be mixed to form a pattern on the surface of the adhesive element.

The first zone and the second zone have dimensions such that the scale of spatial variations of the material within the zone or the surface of the zone is small compared to dimensions of the zone or the surface of the zone. Such variations may be due to random fluctuations in the material, surface roughness, mixing of two compositions or spatial variations of a heat treatment of the material.

The surface of the second zone constitutes at least a part of the adhesive surface of the adhesive layer, i.e. a part of the boundary of the second zone coincide with at least a part of the adhesive surface of the adhesive layer.

The first zone may be within the adhesive layer, such that the first surface is below the adhesive surface of the adhesive layer. This may be the case for an embodiment of the invention wherein the second surface constitutes the entire adhesive surface. An adhesive element according to this embodiment of the invention may be obtained by a heat treatment of the entire surface of the adhesive layer. When the first surface is below the adhesive surface of the adhesive layer, the surface properties associated with the first surface are the properties related to the exposed surface, i.e. the properties that may be measured after the first surface is exposed and possibly allowed to relax.

In a preferred embodiment of the invention the first surface constitutes a part of the adhesive surface of the adhesive element. Thus in this embodiment of the invention the first surface and the second surface each constitutes a part of the adhesive surface of the adhesive layer. According to this embodiment of the invention, an adhesive element is provided comprising an adhesive layer, with properties varying over the surface of the adhesive layer.

In a further embodiment of the invention, the first surface and the second surface form a pattern on the adhesive surface. The first surface and the second surface may both be topologically coherent. The first surface and the second surface may be tangled to form a pattern such as a spiral. In another embodiment of the invention the first surface and/or the second surface are not topologically coherent but comprises a plurality of topologically coherent sub-surfaces. The first surface and the second surface may then e.g. form a pattern such as a repetition of geometric figures.

The adhesive layer may comprise a transition zone wherein the first set of surface properties changes continuously to the second set of surface properties as a function of position. A transitional zone may be obtained by the spatially controlling of the heat input received by the adhesive layer. A transitional zone may also arise due to diffusion of heat in the material and imperfect focusing of the heat source. Thus, a first zone with a first set of surface properties and a second zone with a second set of surface properties, may be separated by a transition zone, wherein the first set of surface properties changes continuously to the second set of surface properties as a function of position.

The set of surface properties comprises at least one surface property. The set of surface properties may comprise at least one functional property, such as the temporal profile of water absorption into the adhesive layer, peel adhesion, tack, etc. The set of surface properties may also comprise a visual property, such as colour, transparency or opacity, or reflection of visible light.

In one embodiment of the invention the set of surface properties comprises the temporal profile of water absorption into the adhesive layer. The temporal profile of water absorption into the adhesive layer may be changed by the heat treatment such that at least initially more water is absorbed into the second zone than into the first zone. In one embodiment of the invention the initial water absorption increases as a result of the heat treatment. The temporal profile of water absorption may comprise time intervals wherein the water absorption into the second zone is lower than the water absorption into the first zone, e.g. an initial decrease of water absorption may after a short while be followed by a more extensive increase of water absorption. The temporal profile of water absorption into the adhesive layer is a particularly relevant property when the adhesive element is intended for application to skin and comprises a water-absorbing component such as hydrocolloids.

In one embodiment of the invention the set of surface properties comprises an adhesive property, such as peel adhesion or tack. It is often advantageous to provide an adhesive element with an adhesive surface of varying adhesive properties, e.g. stronger peel adhesion may be required at the edges of the adhesive surface layer, whereas weaker peel adhesion are sufficient in areas far from edges, and may be desirable e.g. due to a less traumatic removal of the adhesive element in medical applications. In a further embodiment of the invention the adhesive properties of the second surface are reduced compared to the first surface. For example the heat treatment may result in the peel adhesion being reduced in the second surface relative to the first surface.

In one embodiment of the invention the set of surface properties comprises a property affecting the visual appearance of the adhesive layer. The visual appearance of the adhesive layer may be affected by properties such as colour, transparency, opacity and surface roughness. When a property affecting the visual appearance of the adhesive layer is changed by a heat treatment it may be possible to print information on the adhesive layer concerning the use of the adhesive element. Thus at least a part of the first surface or the second surface may be in the shape of letters or contours containing information concerning the use of the adhesive element. The information may contain statements as to the orientation of the adhesive element and the method of application. If for example the adhesive element is comprised in an ostomy body side member the information may further contain marked up lines for cutting holes of various diameters to suit individual stomas.

In one embodiment of the invention the set of surface properties comprises at least two different surface properties. The surface properties are different in that they are not inherently linked such that the value of one property may be derived from the value of the other property alone. The change of a functional property may e.g. be accompanied by the change of a visual property. However, also two functional surface properties may differ in the two zones. The two properties may e.g. be the temporal profile of water absorption into the adhesive layer and an adhesive property or a visual property.

In one embodiment of the invention the adhesive layer is adapted for releasable adhesion to skin. Thus the pressure sensitive adhesive composition constituting the adhesive layer should be adapted to adhere to skin and subsequently to be removed from the skin without causing unacceptable trauma.

The pressure sensitive adhesive composition may be a skin friendly pressure sensitive adhesive composition. In particular an adhesive element according to the invention may be produced from standard materials normally used for preparation of disposable ostomy and wound and incontinence devices.

In one embodiment of the invention the pressure sensitive adhesive composition comprises an adhesive part and an absorbing part. In a further embodiment of the invention, the absorbing part of the pressure sensitive adhesive composition comprises hydrocolloid particles. Such hydrocolloid particles are suitably naturally occurring hydrocolloids such as guar gum, locust bean gum, pectin, alginates, gelatine, xanthan or karaya gum, semisynthetic hydrocolloids such as cellulose derivatives, e.g. salts of carboxymethylcellulose, methylcellulose and hydroxypropylmethylcellulose, sodium starch glycollate and synthetic hydrocolloids such as polyvinyl pyrrolidone, polyvinyl alcohol, polyethylene glycol or certain polyacrylates. The hydrocolloid particles may even be microoolloids such as described in WO 02/066087.

An adhesive element according to the invention may be suitable for use as a semi-manufacture in the production of a medical device, such as dressings, skin- and wound-care devices, fastening means for dressings, ostomy equipment, wound drains, catheters, and similar applications. The adhesive element may thus typically be in the shape of a self-adhesive, flexible, flat skin plate product. In one embodiment of the invention the adhesive element is adapted to form part of an ostomy body side member or a wound care dressing.

In one embodiment of the invention, the heat treatment comprises irradiation of the surface of the adhesive layer with an infrared laser. The heat treatment may also comprise irradiation of the surface of the adhesive layer with a polychromatic lamp. Furthermore the heat treatment may comprise contact heating or convection heating of the adhesive layer.

A second aspect of the invention relates to a method of producing an adhesive element comprising an adhesive layer, the adhesive layer comprising at least a first zone having a first surface associated with a first set of surface properties and at least one second zone having a second surface constituting at least a part of the adhesive surface of the adhesive element, the second surface being associated with a second set of surface properties differing from the first set of surface properties, wherein material as present in the second surface is obtainable by a heat treatment of material in the first surface, said material comprising a pressure sensitive adhesive composition, said method comprising the steps of
providing an adhesive element comprising an adhesive layer,
selecting a heat source,
locating the adhesive layer and the heat source in a relationship enabling a heat treatment of the second surface of the adhesive layer, and
a heat treating the second surface with the selected heat source for a sufficient time for obtaining the second set of properties.

In one embodiment of the invention, the heat treatment comprises contact heating or convection heating of the second surface. The adhesive layer may e.g. be heated in an oven. The temperature should be sufficiently high to modify a set of properties, however the temperature should not be so high that the adhesive layer is destroyed. The heat treatment may also comprise heating by presenting the second surface to a warm object, using the principles of a flat iron or branding iron. The warm object could contact the second surface of the adhesive layer, however due to the adhesive properties of the adhesive surface, it may be practical to separate the warm object from the adhesive layer, e.g. by a fluoropolymer liner or a small air gap.

In one embodiment of the invention, the heat treatment comprises irradiation of the second surface with electromagnetic radiation. The second surface may be irradiated with electromagnetic radiation of a wavelength ranging from 400 nm and up, such as in the infrared range of 750-11,000 nm. Heat treatment by means of irradiation has the advantage that the heat treatment may be restricted to affect the surface of the adhesive layer without heating the entire adhesive element. By irradiation the heat treatment may further be directed to certain parts of the surface of the adhesive layer, whereas other parts of the surface of the adhesive layer may be left untreated.

In a further embodiment of the invention, the heat treatment comprises irradiation of the second surface with electromagnetic radiation in the infrared range. The second surface may e.g. be irradiated with an infrared laser. The irradiation may e.g. be performed using a conventional continuous or pulsed CO₂-laser or Nd:YAG laser, or a conventional diode laser. The energy density sufficient for changing a set of surface properties of the adhesive layer is dependent on the absorption at the given wavelength. A typical wavelength for a CO₂-laser is 10600 nm, whereas for a diode or Nd:YAG laser a typical wavelength lies in the range of 800-1100 nm. Thus for a CO₂-laser the energy density may suitable be in the range of 0.1-100 J/cm², such as in the range of 1-10 J/cm². For a diode or Nd:YAG laser the energy density may be in the range of 1-5000 J/cm², such as in the range of 10-500 J/cm². For some applications it is advantageous to add a component to the material that increases the absorption of the laser light.

The effect of a continuous CO₂-laser may e.g. be in the range of 12-35 W and a suitable heat treatment may e.g. be obtained by radiation with a beam of diameter 0.1-0.5 mm being moved relative to the surface with a speed of 2000-6000 mm/s. For a diode laser the effect may typically be in the range of 50-500 W and a suitable heat treatment may e.g. be obtained with a beam diameter of 1-5 mm and a velocity of 100-2000 mm/s.

Alternatively the heat treatment may comprise irradiation with a polychromatic lamp. In this case the peak intensity may also occur at a wavelength in the infrared range.

In one embodiment of the invention the heat treatment is performed using a mask for protecting parts of the surface to be less treated or remain un-treated, said mask covering a part of the surface of th adhesive layer. The mask should be made of a material protecting the material covered by the mask from the heat treatment, such that the effect of the heat treatment is reduced or even absent in parts of the adhesive layer which were covered by the mask during the heat treatment (e.g. first zone) as compared to parts which were not covered by the mask (e.g. second zone).

In one embodiment of the invention the heat treatment is performed progressively such that the heat treatment of a first portion of the second zone of the adhesive layer is delayed compared to the heat treatment of second portion of the second zone of the adhesive layer. Thus the heat treatment may advance over the surface of the adhesive element. In particular the heat treatment may comprise writing a pattern on the adhesive surface using an infrared laser equipped with suitable optics such as galvanometer-scanner mirrors. This is appealing in that the pattern may easily be changed from one product to the next by reprogramming of the laser.

In one embodiment of the invention the heat treatment is performed e.g. by radiation with a laser through a semi-transparent liner in contact with the adhesive layer. Such a protective cover or release liner may for instance be a siliconized polymer liner. Performing a laser heat treatment through a semi-transparent liner may be advantageous for some applications, as this permits the heat treatment to be carried out at a late stage of the production of the adhesive element or even at a late stage of the production of a product incorporating the adhesive element. Thus, it is possible to obtain a variety of products from a common base product by modifying the properties of the base product by a heat treatment.

### DESCRIPTION OF THE PREFERRED EMBODIMENTS

The invention is now explained more in detail with reference to the drawings showing preferred embodiments of the invention.

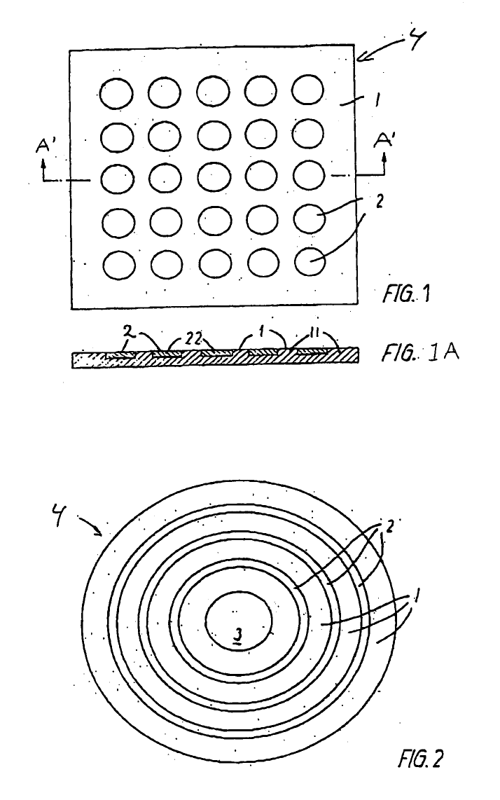

FIG. 1 shows an adhesive element in the shape of a flat plate-like element. The adhesive surface 4 comprise a first surface 1 and a second surface 2. The first surface is topologically coherent whereas the second surface is topologically incoherent. The second surface and the first surface form a pattern in the shape of dots on the adhesive surface 4. A set of surface properties is different for the first surface and the second surface. FIG. 1b shows the cross section A′-A′ of the adhesive element. A first zone 11 comprises the first surface 1 and a second zone 22 comprises the second surface 2.

FIG. 2 shows an adhesive element in the shape of a flat plate-like element for the manufacture of an ostomy body side member. The adhesive element has a hole 3 for receiving the stoma of the patient. Furthermore the adhesive surface 4 comprise a first surface 1 and a second surface 2. The first surface and the second surface are both topologically incoherent and form a pattern in the shape of rings on the adhesive surface 4. A set of surface properties is different for the first surface and the second surface. Similar embodiments without the hole 3 may be used for other medical applications.

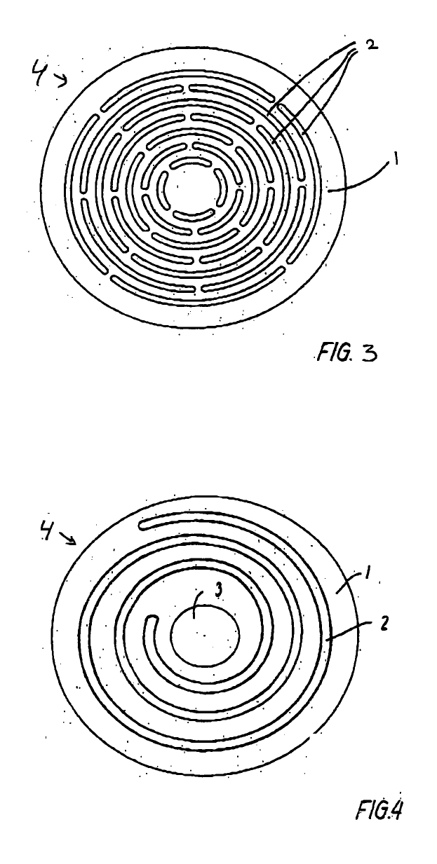

FIG. 3 shows another embodiment of the invention, wherein the second surface forms a circular pattern wherein the circles are broken.

FIG. 4 shows another embodiment of the invention, wherein the first surface 1 and the second surface 2 are both topologically coherent and tangled to form a pattern in the shape of a spiral.

The embodiments shown in the figures may e.g. be realised by a heat treatment of the SIS-based hydrocolloid-containing adhesive composition described in EP11198261. The heat treatment may be performed using a CO₂ continuous laser marking system with an effect of 35 W, the laser being removed relative to the adhesive surface with a speed of 5500 mm/s. The heat treatment of the second zone results in a six-fold increase of the water absorption over the first hour and a 50% reduction in peel adhesion as compared to th untreated first zone.

Materials and Methods

Water Absorption Measurement

The adhesive was pressed into a plate with a thickness of 1 mm. A sample of 25×25 mm² was then punched out and adhered on an object glass (slide). The object glass with the sample was weighed and placed in a beaker with 0.9% isotonic saline at 37° C. After a given time, the object glass with the sample was removed from the beaker, excess water was shaken off, and the object glass with the sample was weighed again after drying the surface of the object glass not covered with adhesive. The increase in weight was recorded as the water absorption at the given time.

Measurement of Peel Adhesion

A sample of 25×100 mm² was cut from the adhesive and firmly pressed on to a thoroughly cleaned steel plate. A 25×300 mm² piece of auxiliary tape was then placed on the top of the adhesive and the whole sample pressure rolled to assure firm adhesion between the tape and the adhesive to be tested. After conditioning for 30 minutes at 23±3° C. the sample was mounted in a tensile testing machine and a 90° C. peel test was carried out at a speed of 304 mm/min. The results is given in N/25 mm.

### REFERENCE EXAMPLE A

A pressure sensitive adhesive composition was prepared of the type and coated onto film as disclosed in U.S. Pat. No. 4,367,732. The exact composition was 23.6% styrene-isoprene-styrene block copolymer (Kraton D1107), 33.9% tackifier resin (Arkon P90), 5.9% DOA oil, 35.3% sodium carboxy-methylcellulose (Blanose 9H4XF), 0.1% titanium dioxide and 1.2% antioxidant.

### REFERENCE EXAMPLE B

A pressure sensitive adhesive composition as disclosed in example 2 of WO 99/11302 was prepared.

### REFERENCE EXAMPLE C

A pressure sensitive adhesive composition as disclosed in example 8 of EP 1198261 was prepared.

### EXAMPLE 1

The surface of an adhesive material identical to that of reference example A was heat-treated using a conventional continuous CO₂-laser marking system equipped with galvanometric-scanner mirrors. A number of experiments were carried out with an average laser power between 12 and 35 W and a marking speed between 2500 and 5500 mm/s. In each case an area of 40×100 mm² of the surface was treated. The laser spot had a diameter of approximately 200 μm and the treatment took less than 10 seconds.

### EXAMPLE 2

The surface of an adhesive material identical to that of reference example B was heat treated as described in example 1.

### EXAMPLE 3

The surface of an adhesive material identical to that of reference example C was heat treated as described in example 1.

### EXAMPLE 4

The surface of an adhesive material identical to that of reference example C was heat-treated using a conventional pulsed CO₂-laser marking system using a 18×18 mm² metal mask. The repetition rate was 20 Hz and the energy density 2.9 J/cm². The optics defined an 8×8 mm² area on the surface of the adhesive which was treated.

### EXAMPLE 5

An adhesive material identical to that of reference example C was heat-treated using a conventional oven for 5-60 minutes at 110° C. or 150° C.

### EXAMPLE 6

Measurement of peel adhesion on samples treated with the continuous laser marking system (examples 1-3)

| | | | Peel adhesion | Peel adhesion |
|---|---|---|---|---|
| | | | (N/25 mm) | (N/25 mm) |
| Material | Power (W) | Speed (mm/s) | treated | untreated |
| A | 24 | 4000 | 5 | 20 |
| B | 12.5 | 2500 | 0 | 11 |
| C | 35 | 5500 | 6 | 33 |

Measurement of peel adhesion on a sample treated with the pulsed laser marking system (example 4)

| | | Energy | Peel adhesion | Peel adhesion |
|---|---|---|---|---|
| | Repetition rate | density | (N/25 mm) | (N/25 mm) |
| Material | (Hz) | (J/cm²) | treated | untreated |
| C | 20 | 2.9 | 6 | 33 |

It appears that laser heating of the reference adhesives results in a significant reduction of the peel adhesion

### EXAMPLE 7

A surface of reference material B was heat treated with a continuous laser system as in example 2 using a power of 12.5 W and a speed of 2500 mm/s. Heat treatment was performed in a fine pattern, the heat treated part of the pattern covering 50% of the total surface area. The peel adhesion is compared to the non-treated and fully treated samples in the table.

| Treated area | 0% | 50% | 100% |
|---|---|---|---|
| Peel adhesion (N/25 mm) | 11 | 5 | 0 |

The example demonstrates that it is possible to obtain a heat treated pattern on the surface of an adhesive and that the resulting mean peel adhesion scales with the ratio of treated to non-treated surface.

### EXAMPLE 8

Color and appearance before and after heat treatment of the materials given in reference examples A, B and C.

| | | Appearance, | Appearance, |
|---|---|---|---|
| Material | Treatment | untreated | treated |
| A | Continuous Laser | Light yellow | White or light |
| | (24 W, 4000 mm/s) | | brown |
| B | Continuous Laser | Light brown | Brownish |
| | (12.5 W, 2500 mm/s) | | |
| C | Continuous Laser | Transparent | Semi transparent, |
| | (35 W, 5500 mm/s) | | brownish look |
| C | Pulsed Laser | Transparent | Brownish |
| | (20 Hz, 2.9 J/cm²) | | |
| C | Oven | Transparent | Light brownish |
| | (30 minutes at 110° C.) | | coloration |

This example demonstrates that a color change can be obtained for all reference materials and with different kinds of heat treatment.

### EXAMPLE 9

Initial water absorption before treatment of the materials given in reference examples A, B and C.

| | 10 min | 1 h |
|---|---|---|
| Material | (g/cm²) | (g/cm²) |
| A | 0.06 | 0.07 |
| B | 0.08 | 0.17 |
| C | 0.01 | 0.01 |

Initial water absorption after heat treatment of the materials given in reference examples A, B and C.

| | | 10 min | 1 h |
|---|---|---|---|
| Material | Treatment | (g/cm²) | (g/cm²) |
| A | Continuous Laser | 0.07 | 0.15 |
| | (24 W, 4000 mm/s) | | |
| B | Continuous Laser | 0.07 | 0.17 |
| | (12.5 W. 2500 mm/s) | | |
| C | Continuous Laser | 0.02 | 0.06 |
| | (35 W, 5500 mm7s) | | |
| C | Pulsed Laser | 0.07 | 0.04 |
| | (20 Hz, 2.9 J/cm²) | | |
| C | Oven | 0.06 | 0.04 |
| | (30 minutes at 110° C) | | |

It is observed that a heat treatment of a SIS-based hydrocolloid-containing pressure sensitive adhesive such as reference material A or C leads to an Increase in the initial water absorption compared to that obtained with the untreated material. The apparent decrease in weight from 10 minutes to 1 hour observed for pulsed laser and oven treatments of material C is caused by disintegration and loss of adhesive into the saline solution. For a PIB-containing adhesive such as material B the initial water absorption is largely independent of the heat treatments used here.

### EXAMPLE 10

A piece of reference material C was covered by a 110 micron thick blown PP/PE Co-polymer siliconized (1803/1850) liner from Huhtamaki. This liner is semitransparent to laser light at the wavelength of a CO₂-laser (10.6 microns). The covered adhesive was heat treated through the liner but otherwise as described in example 3. After treatment the liner could easily be removed, the treated areas on the surface of the adhesive had a brownish appearance and a distinct reduction in peel adhesion. This example shows that heat treatment of an adhesive covered by a liner is possible through the liner if this is semi-transparent to the laser light.

1. An adhesive element comprising an adhesive layer, the adhesive layer comprising at least:
a first zone comprising a first surface associated with a first set of surface properties and
at least one second zone comprising a second surface constituting at least a part of the surface of the adhesive element, the second surface being associated with a second set of surface properties, the second set of surface properties differing from the first set of surface properties,
wherein material as present in the second surface is obtainable by a heat treatment of material in the first surface, said material comprising a pressure sensitive adhesive composition.

2. An adhesive element as claimed in claim 1, wherein the first surface constitutes a part of the adhesive surface of the adhesive element.

3. An adhesive element as claimed in claim 2, wherein the first surface and the second surface form a pattern on the adhesive surface.

4. An adhesive element as claimed in claim 1, wherein the set of surface properties comprises the temporal profile of water absorption into the adhesive layer.

5. An adhesive element as claimed in claim 1, wherein the set of surface properties comprises an adhesive surface property of the adhesive layer.

6. An adhesive element as claimed in claim 1, wherein the set of surface properties comprises a property affecting the visual appearance of the adhesive layer.

7. An adhesive element as claimed in claim 1, wherein the set of surface properties comprises at least two surface properties.

8. An adhesive element as claimed in claim 1, wherein the adhesive layer is adapted for releasable adhesion to skin.

9. An adhesive element as claimed in claim 1, wherein the pressure sensitive adhesive composition comprises hydrocolloid particles.

10. An adhesive element as claimed in claim 1, said adhesive element being adapted to form part of a medical device, such as an ostomy body side member or a wound care dressing.

11. An adhesive element as claimed in claim 1, wherein the heat treatment comprises irradiation of the surface of the adhesive layer with an infrared laser.

12. A method of producing an adhesive element comprising an adhesive layer, the adhesive layer comprising at least a first zone having a first surface associated with a first set of surface properties and at least one second zone having a second surface constituting at least a part of the adhesive surface of the adhesive element, the second surface being associated with a second set of surface properties differing from the first set of surface properties, wherein material as present in the second surface is obtainable by a heat treatment of material in the first surface, said material comprising a pressure sensitive adhesive composition, said method comprising the steps of:
providing an adhesive element comprising an adhesive layer,
selecting a heat source,
locating the adhesive layer and the heat source in a relationship enabling a heat treatment of the second surface of the adhesive layer, and
heat treating the second surface with the selected heat source for a sufficient time for obtaining the second set of properties.

13. A method as claimed in claim 12, wherein the heat treatment comprises contact heating or convection heating.

14. A method as claimed in claim 12, wherein the heat treatment comprises irradiation of the second surface with electromagnetic radiation with a wavelength above 400 nm.

15. A method as claimed in claim 14, wherein the irradiation comprises irradiation with a laser or a polychromatic lamp.

16. A method as claimed in claim 12, wherein the heat treatment is performed using a mask for protecting parts of the surface to be less treated, said mask covering a part of the surface layer.

17. A method as claimed in claim 12, wherein the heat treatment is performed progressively such that the heat treatment of a first portion of the second zone of the adhesive layer is delayed compared to the heat treatment of second portion of the second zone of the adhesive layer.

18. A method as claimed in claim 12, wherein the heat treatment comprises writing a pattern on the surface of the adhesive layer with an infrared laser.

19. A method as claimed in claim 12, wherein the heat treatment is performed through a liner in contact with the adhesive layer.

20. An adhesive element obtainable by a method as claimed in claim 12.
